(19) United States
(12) Patent Application Publication
(10) Pub. No.: US 2011/0034209 A1
(43) Pub. Date: Feb. 10, 2011

(54) WIRELESS TECHNOLOGY AS A DATA CONDUIT IN THREE-DIMENSIONAL ULTRASONOGRAY

(76) Inventors: Boris Rubinsky, El Cerrito, CA (US); Antoni Ivorra, Berkeley, CA (US); Yair Granot, Modi'in (IL); Arie Meir, Kiriat Motzkin (IL)

Correspondence Address: UC Berkeley - OTL;Bozicevic, Field & Francis LLP, 1900 University Avenue, Suite 200, East Palo Alto, CA, 94303, US

(21) Appl. No.: 12/856,323

(22) Filed: Aug. 13, 2010

Related U.S. Application Data
(63) Continuation-in-part of application No. 12/664,866, filed on May 21, 2010.
(60) Provisional application No. 61/234,609, filed on Aug. 17, 2009.
(60) Provisional application No. 61/239,644, filed on Sep. 3, 2009.
(60) Provisional application No. 61/254,941, filed on Oct. 26, 2009.
(60) Provisional application No. 60/936,063, filed on Jun. 18, 2007.

(51) Int. Cl. H04W 4/00; G06K 9/00

(52) U.S. Cl. 455/556.1; 382/131

(57) ABSTRACT

An imaging system, having: an imaging data acquisition device; a remote image reconstruction and data processing facility; and a wireless data transfer to transmit raw data from the data acquisition device to the remote facility. At the facility, the raw data is processed to prepare a diagnostic image that can be transmitted to an expert or non-expert, or transmitted back to the display of the wireless data transfer device.

### CROSS REFERENCE TO RELATED APPLICATIONS

This application is a continuation-in-part of U.S. patent application Ser. No. 12/664,866, filed on May 21, 2010; which is a national stage entry of PCT/US2008/007605, filed on Jun. 17, 2008; which claims priority from U.S. Provisional Application No. 60/936,063, filed on Jun. 18, 2007; all of which are herein incorporated by reference in their entirety.

This application also claims priority from U.S. Provisional Application No. 61/234,609, filed on Aug. 17, 2009; U.S. Provisional Application No. 61/239,644, filed on Sep. 3, 2009; and U.S. Provisional Application No. 61/254,941, filed on Oct. 26, 2009; all of which are herein incorporated by reference in their entirety.

### STATEMENT REGARDING FEDERALLY-SPONSORED RESEARCH AND DEVELOPMENT

This invention was made with government support under NIH Grant No. R01 RR018961 awarded by the U.S. National Institutes of Health. The U.S. Government has certain rights in this invention.

### BACKGROUND OF THE INVENTION

1. Field of the Invention

The present invention generally relates to imaging systems; and more specifically to a medical imaging system using cellular phone technology.

2. Background Art

Medical imaging has become indispensable to modern medicine. However, current medical imaging systems are expensive, and require trained operators to use, update, and to repair. In addition, the costs of shipping medical imaging equipment from developed nations into lesser-developed nations can also be prohibitive, and resources may not be available to operate the equipment when it arrives. Moreover, a large part of the costs of conventional medical imaging systems are due to the fact that they are self-contained units that combine data-acquisition hardware with software-processing hardware in one device. As a result, much of the world's population lacks access to standard medical imaging systems such as ultrasounds, X-rays, and other imaging devices.

Cellular phones, however, are widely available, even in remote areas. In fact, in many developing countries, cellular phones are available even when standard land lines are not available. Provided herein is a system that uses wireless networks (e.g., cellular networks) to provide medical imaging resources to patients in places and conditions where it was previously limited or unavailable. For example, the present invention may be used to provide 3-D ultrasonography, which is expensive and therefore used in limited ways, to patients in both developed and under-developed parts of the world.

### BRIEF SUMMARY OF THE INVENTION

One aspect of the present invention is to provide a system in which wireless data transfer technology is used as an enabling component to transfer data among spatially separated components of a medical imaging system. It is to be understood, however, that the present invention can also be used for producing non-medical images. Other uses that do not entail any imaging are also encompassed by the present invention, as will be detailed below.

In one embodiment, the present invention uses a conventional cellular phone to serve as a data conduit between a medical imaging data acquisition device at a patient site and a remote image reconstruction and data processing facility. The cellular phone may also be used for local image display and for local processing at the patient site. As such, a standard cellular phone is used to transfer data between two independent components of a medical imaging system (e.g., the data acquisition component and the image reconstruction component).

In one embodiment, the invention comprises a simple data acquisition device (with limited controls and no image display capability) at a patient site. The data acquisition device is connected via cellular phone to an advanced central image reconstruction facility. The cellular phone transmits raw, unprocessed, or minimally processed data from the patient site to the central image reconstruction facility. The raw image data is then processed and reconstructed at the central image reconstruction facility and sent back to the cellular phone for display on the screen of the cellular phone. Such a system is significantly advantageous over conventional telemedicine where the image reconstruction and control is at the patient site and telecommunication is simply used to transmit processed images from the patient site. Alternatively, the data transfer back to the cellular phone can be audible (instead of, or in addition to being visual). For instance, a beep could be produced when a medical condition such as internal bleeding is detected. Moreover, the audible signal may also be in the form of a telephone voice-mail message. Alternatively, the image reconstruction facility can send the image to a physician, hospital, or other location instead of sending it back to the cellular phone.

In one exemplary application, the present system is used with electrical impedance tomography being the medical imaging modality. However, it is to be understood that the present invention is not so limited, and that other imaging modalities may also be used. For example, ultrasound, X-rays, magnetic resonance imaging (MRI), computerized tomography (CT) and positron emission tomography (PET) may be used for imaging. Moreover, in alternate uses, non-imaging data may also be handled by the present invention. The present invention thus encompasses any system in which cellular phones are used as an integral, internally embedded, and enabling component that transfers data among the components of the system.

One advantage of the present design of the medical imaging system is that the most complex part of the system (i.e., the processing software used to reconstruct the raw data into meaningful images) resides at one central facility. Thus, there is no need for people who are highly trained in image processing to be present in the field (i.e., at the actual patient site, which may be in parts of the world with limited resources). Thus, an important advantage of the present invention is that it significantly reduces costs (since a single processor facility services multiple cellular phone imager systems). Another advantage is that maintenance and software and hardware upgrades can all be done at the central image processing facility.

The present invention may also operate on a cellular phone that can send and receive pictures, or audio and video clips. In addition, a centralized database can be maintained in the data processing facility. This database may be compatible with all imaging modes and may be used to track specific patients or to compare images from one patient to another. In other embodiments, the cellular phone transmits data to the central image processing facility, but does not receive information, data, or images back from the facility. Rather, trained operators and medical professionals at the central data processing facility, or another location may perform the diagnosis, or collect the data, without displaying an image on the phone screen for the patient to view. Thus, once processed at the central image processing facility, a diagnostic image(s) or other processed data can be sent anywhere necessary by various means such as phone or Internet.

In further embodiments, the present invention need not be limited to imaging systems at all, but may be used in other contexts as well. For example, in some aspects, the cellular phone is simply used as a data conduit between any two devices to replace hard wiring such that the cellular phone is a “middle node” of a system (thus permitting component devices of the system to be positioned at various locations). This optional embodiment is in contrast to existing communication systems in which cellular phones operate as the end node of the system. Thus, the present invention also provides a system of transferring data between parts of a complex device using cellular phone communication protocols, comprising: a first system component of a complex device; a second system component of a complex device; and a cellular phone-type device, wherein raw data is sent through the cellular phone-type device from the first system component to the second system component of the complex device.

In another alternative embodiment, there is provided an imaging system, centered on wireless technology and cloud computing, which is designed to overcome the problems of increasing health technology costs. For example, provided is a wireless, distributed network, and central (cloud) computing enabled three-dimensional (3-D) ultrasound system. Specifically, a 3-D high-end ultrasound scan is produced at a central computing facility using raw data acquired at a remote patient site with an inexpensive low-end ultrasound transducer designed for two-dimensional (2-D) imaging. Such system uses a mobile device and a wireless connection link to transmit raw data from the patient site to the central computing facility. Producing high-end 3-D ultrasound images with simple low-end transducers significantly reduces the cost of imaging and removes the requirement of having a highly trained imaging expert at the patient site. Specifically, the need for hand-eye coordination and the ability to reconstruct a 3-D mental image from 2-D scans, which requires a highly trained physician for the operation of the system, is eliminated. As such, relatively untrained medical workers, particularly in developing nations or at remote accident sites or battlefield, can administer imaging and provide a more accurate diagnosis.

### BRIEF DESCRIPTION OF THE FIGURES

FIG. 1 is an illustration of the operation of the present invention (for a patient self-screening for breast cancer tumors).

FIG. 2 is a schematic representation of a frequency-division multiplexing electrical impedance tomography technique performed by a data acquisition device in accordance with the present invention.

FIG. 3 is an illustration of an exemplary architecture of a data acquisition device that can be used in accordance with the present invention.

FIG. 4A is an illustration of an exemplary minimally invasive surgical application in which a data acquisition device is used with a gel representing a tissue area treated with electroporation surrounded by normal tissue.

FIG. 4B is an illustration of a processed image corresponding to FIG. 4A as seen on the screen of a cellular phone.

FIG. 5A is an illustration of an exemplary breast cancer detection application in which a data acquisition device is used with a gel representing a breast cancer tumor surrounded by normal tissue.

FIG. 5B is an illustration of a processed image corresponding to FIG. 5A as seen on the screen of a cellular phone.

FIG. 6 is an illustration of the present invention as used in a non-imaging data transfer context, with a cellular phone operating as a middle node of the system.

FIG. 7 is a second illustration of the present invention as used in a general medical data transfer context, with a cellular phone operating as a middle node of the system.

FIG. 8A is a schematic illustration of one embodiment presented herein.

FIG. 8B illustrates a mobile console architecture.

FIG. 8C illustrates a server architecture.

FIG. 9 is a schematic illustration of one embodiment presented herein.

FIG. 10 is a photograph of an experimental agar based box-shaped phantom, developed to test an embodiment presented herein.

FIG. 11 provides ultrasound images of the experimental phantom of FIG. 10.

FIG. 12 is a schematic illustration of one embodiment presented herein.

### DETAILED DESCRIPTION OF THE INVENTION

### (a) Medical Imaging Systems:

In accordance with the present invention, a conventional cellular phone is used as an integral and enabling component of a spatially dispersed medical imaging system.

In one embodiment, the cellular phone and a data gathering device are used at a patient site, with the cellular phone communicating with a multi-server processing center (possibly in a completely different part of the world). The multi-server processing center simultaneously serves many patient data gathering devices in the field. The multi-server processing center thus acts as a central image reconstruction and data processing facility.

Specifically, the cellular phone at the patient site transfers the raw data to an image reconstruction and data processing facility which then returns a reconstructed image through the cellular phone. The cellular phone is also used to display the image and for some local processing at the patient site. As will be explained, the fact that the image itself is produced in a centralized location, and not on the measurement device, has many advantages. For example, the data passing through the cellular phone to the image reconstruction facility can be analyzed by experts, and the software in the centralized facility can be continuously upgraded.

As will be shown, the cellular phone may be used in one of three ways: (a) as a communication channel for long distance data transfer between the data acquisition device and the image reconstruction and data processing facility; (b) as a local image display and Graphical User Interface (GUI) at the patient site in the field; and optionally (c) as a supporting limited local data processing unit at the patient site in the field, to provide partial support of the distributed system.

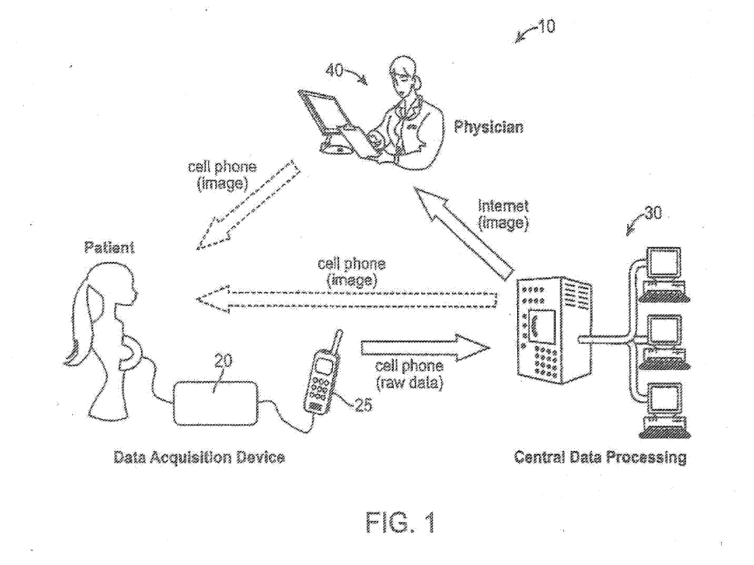

A schematic diagram of the system is given in FIG. 1 in which an imaging system 10 is provided. System 10 comprises an imaging data acquisition device 20; an image reconstruction and data processing facility 30; and a handheld cellular phone type device 25. Cellular phone 25 wirelessly transmits raw data from imaging data acquisition device 20 to remote image reconstruction and data processing facility 30. In addition, cellular phone 25 also receives image data from remote image reconstruction and data processing facility 30 to display an image on a screen of the handheld cellular phone 25. As described herein, the term “cellular phone” is intended to include any cellular phone type-device, including but not limited to a cellular phone, Personal Digital Assistant (PDA), iPhone™, or Blackberry™ device, a custom electronic device containing a wireless means of data transfer, or a personal or notebook computer with cellular phone capabilities. Further, as described herein, the term “wireless data transfer device” is intended to include, but not be limited to, a cellular phone (as defined above) and/or other equivalent systems for wirelessly transferring data.

In one embodiment, a plurality of separate imaging data acquisition devices 20 and associated cellular phones 25 are used together with a single central single image reconstruction and data processing facility 30. (For clarity in FIG. 1, only one data acquisition device 20 and cellular phone 25 are illustrated). In one embodiment, image reconstruction and data processing facility 30 may comprise a large, centralized multi-server processing facility. As such, image reconstruction and data processing facility 30 may be located in a resource-rich part of the world, and be staffed with trained imaging professionals. Image reconstruction and data processing facility 30 may receive data from, and send images to, a plurality of cellular phones 25, which may be located at various patient sites throughout the world.

In one embodiment of the invention, a data viewing center 40 is in communication with remote image reconstruction and data processing facility 30. The data viewing center 40 may include at least a computer screen for viewing the same image that is displayed on the screen of the cellular phone 25. The data viewing center 40 and the remote image reconstruction and data processing facility 30 may communicate over the Internet, and/or they may communicate wirelessly.

As can be seen in FIG. 1, images may be transmitted to the patient for display on the screen of cellular phone 25 either by: (a) direct wireless transmission from image reconstruction and data processing facility 30 to cellular phone 25; or (b) direct wireless transmission from data viewing center 40 to cellular phone 25; or (c) by both methods (a) and (b) together. This is an advantage of the present invention in that cellular phone 25 may receive image data from either location and from substantial distances, through cellular phone services that are not dedicated to this application. Using commercial cellular phones and cellular phone services for data transfer substantially reduces the cost of the data transfer and substantially increases the ability to implement this invention without the need for a special infrastructure. Images sent wirelessly to cellular phone 25 are shown as two dotted arrows in FIG. 1.

The data sent from data acquisition site (i.e., from data acquisition device 20 through the cellular phone 25 to image reconstruction and data processing facility 30) is raw unprocessed data, or minimally processed data. Data transmitted from imaging data acquisition device 20 through cellular phone 25 to image reconstruction and data processing facility 30 may optionally be sent by e-mail, SMS, MMSTelnet or other equivalent wireless modality. Moreover, the data transmitted from imaging data acquisition device 20 to remote image reconstruction and data processing facility 30 may be sent as analog data through a voice channel of the cellular phone 25. Other communication options are possible as well.

The present invention thus also provides a method of imaging, comprising: acquiring raw data from data acquisition device 20; transferring the acquired raw data wirelessly with cellular phone 25 using commercial cellular phone services to data processing facility 30; constructing an image from the raw data at image reconstruction and data processing facility 30; transferring the constructed image from image reconstruction and data processing facility 30 to cellular phone 25 through commercial cellular phone services and then displaying the constructed image on a screen of cellular phone 25.

Optionally, transferring the acquired raw data wirelessly with cellular phone 25 to image processing and reconstruction facility 30 comprises: transferring acquired raw data from a plurality of cellular phone-type devices 25 (at different patient locations around the world) to a single central image processing and reconstruction facility 30. Optionally, some or all of the constructed images may be transferred from image reconstruction and data processing facility 30 to a data viewing center 40. In further aspects, images and data may be transferred from data viewing center 40 to cellular phone 25.

In various aspects of the present invention, cellular phone 25 may be operated in one or more of the following ways. First, it can be used as a simple modem. Depending on the cellular phone model, many phones on the market today have either a built-in option or a possible add-on to enable them to function as a modem. This option may require that cellular phone 25 is operated together with either a personal computer or an integrated modem interface. Secondly, data can be uploaded to cellular phone 25 through a wireless or a wired link and then sent using the cellular phone's links such as Email, short messaging service (SMS), multimedia messaging service (MMS) Tetnet. This depends on the types of commercial service that the cellular provider supports. However, at least SMS is a widely available option today, even in the simplest cellular networks. Third, a customized modem many be used. An advantage of this third approach is that it would be completely independent of the cellular phone model. Thus, it would be possible to implement the customized modem with a suitable speaker that would match an ordinary cellular phone microphone. In this case, the cellular phone uses the voice channel to transmit an analog signal (much like a fax). This also offers advantages in terms of cellular phone compatibility.

A further advantage of the present system is that almost every cellular provider, whether it is using GSM (global system for mobile communications), CDMA (code division multiple access) or other protocols supports a few PDA (personal digital assistant) like cellular phone models that are relatively easy to work with and connect to. However, an intermediate option is to use cells phones that support some minimum features such as USB (universal serial bus) connection and color display. Using commercial cellular providers and cellular phone data transfer technology has the advantage that it reduces the cost and the complexity of the system and it removes the need to build a dedicated data transfer system.

As stated above, the processed image can be displayed on the screen of the cellular phone. An advantage of using the cellular phone for the final image display and GUI is that creating the cellular phone GUI application depends on the cellular phone model and its support of Java or a similar technology. As such, the interfaces for displaying the final images on a plurality of cellular phones at different patient locations need not be controlled from the central data processing facility. This is a further advantage of the present invention since the present system thus does not require a built-in display and/or keyboard and the user will not need a PC to use the device (although that is also an option as laptops are widely available). Using the cellular phone's keypad, the user can also configure the system, run built-in test functions and operate the device. Optionally, the cellular phone can be also used in a limited way for some of the data processing. This option may be useful in the case of a PDA-like cellular phone model since these PDA cellular phones have relatively powerful processors.

The present invention also provides a method of imaging, comprising: acquiring raw data required for imaging with a mostly self-supported device dedicated primarily to data acquisition; transferring the acquired data wirelessly with a cellular phone through a commercial cellular phone service provider; and producing the image with a distant mostly self-supported device dedicated primarily to production of an image and data processing. The image can be transferred from the image production device to the cellular phone through non-dedicated commercial cellular phone services; and the image can be displayed on the cellular phone screen.

The present invention also provides a method of acquiring raw data and sending the data through a cellular phone to reconstruct the data remotely, comprising: acquiring an image with an imaging data acquisition device; using a handheld cellular phone type-device to wirelessly transmit data representing the image from the imaging data acquisition device to a remote image reconstruction and data processing facility. In various aspects, the handheld cellular phone type-device receives, or does not receive, data from the remote image reconstruction and data processing facility.

In one embodiment, imaging data acquisition device 20 is a medical imaging data acquisition device, and system 10 displays a medical image on the screen of cellular phone 25 (for the patient or operator to view).

In one embodiment, the medical imaging methodology is electrical impedance tomography (EIT), and medical imaging data acquisition device 20 is an electrical impedance tomography system. It is to be understood, however, that the present invention is not so limited and that alternate imaging methodologies may be used. An advantage of using the present invention with EIT is that the “front end hardware” (i.e.: data acquisition device 20) is relatively inexpensive. In addition, EIT use measurements of currents and voltages from a set of electrodes placed outside the tissue or the body can be used to produce an image of the interior of the tissue or body, which can then be displayed as a map of the electrical impedance.

Moreover, EIT image reconstruction is computationally demanding, and requires sophisticated software. The image is reconstructed through a solution of the so called “inverse problem” (i.e. determining impedance distribution inside the object from electrode current and voltage measurements around the object). Since the formulation of the problem is ill-posed in a mathematical sense, adequate reconstruction of the data into an image requires elaborate calculations that necessitate powerful signal processors and computer memory. The advantage of the present invention is that these functions are carried out in central image reconstruction and date processing facility 30 (as opposed to being carried out with equipment at the patient site).

Systems for separating the functions of data acquisition from those of processing and imaging have been set forth in U.S. Pat. No. 6,725,087, incorporated herein by reference in its entirety for all purposes. Specifically, the system set forth in U.S. Pat. No. 6,725,087 separates the functions of data acquisition from those of processing and imaging, and by connecting the data acquisition, processing and imaging components through a communication network, permit the data acquisition, processing and imaging functions to be carried out at disparate locations within the network. The present invention represents a novel and non-obvious advancement over that the system of U.S. Pat. No. 6,725,087 in that the present invention uses cellular phone-type device for the transmission of data. In addition, the present invention uses a cellular phone's own screen to display the image to the patient or user. The advantage of using broad-use commercial cell phone technologies are that the cost of data transfer is substantially reduced and the need for a hard-wired infrastructure is eliminated, thereby reducing cost and increasing the geographical range in which this technology can be applied.

When performing EIT, image processing and reconstruction facility 30 may advantageously be used to implement tasks that are not usually implemented in clinical systems due to their demanding requirements in terms of processing power and/or memory. For example: real-time mesh generation for scenarios where the location of the electrodes may change, or hierarchical meshing in real time for regions where some inhomogeneity is detected, or suggestions on where to place the data gathering elements to obtain better information.

In optional exemplary methods of use, the present invention can be used to detect cancer tumors or monitor minimally invasive surgical procedures, such as electroporation (the permeabilization of the cell membrane with electrical pulses for genetic engineering, drug delivery, or tissue ablation).

Advantages of the invention include the fact that there is no need to manipulate the imaging software at the patient site. In addition, an excellent quality of imaging can be obtained at the data processing site. Non-dedicated commercial cellular phones are ubiquitous, cheap and replaceable. Also, the cost of the data acquisition system (20 and 25) is low relative to the cost of the reconstruction system (facility 30) for a single imaging system. Furthermore the use of cellular phones makes the concept feasible at sites that do not have readily available data transfer infrastructure and without the need to build an infrastructure.

Although the present system is ideally suited to medical imaging, potential other medical applications exist that could employ the use of cellular phones in the mode described above and that involve the steps of acquisition of raw data, the processing of the raw data and the display of the processed data.

For example the present system can be used to detect the occurrence of internal bleeding through such technologies as those described in “Gonzalez, A. C., Rubinsky, B. “A theoretical study on magnetic induction frequency dependence of phase shift in oedema and haematoma”. Physiol. Meas. 27 (2006) 829-838.” and “Cesar A Gonzalez, Liana Horowitz, Boris Rubinsky, Detection of intraperitoneal bleeding by inductive phase shift spectroscopy, IEEE Trans. on Biomedical Engineering, Vol 54. No 5, May 5, 2007”. Particular to those systems is that two electromagnetic coils or magnetrons are placed in such a way that the tissue of interest is between the coils. The relation between the emitted and received electromagnetic signals is monitored at all times in a wide range of frequencies. Changes in the relation between the emitted and the received signals are used to detect changes in tissue properties indicative of such occurrences as edema, ischemia, internal bleeding. A possible application of this system is to detect internal bleeding in women after childbirth. Statistics show that one of four women who die at childbirth the cause of death is undetected internal bleeding. According to our present invention, the raw data from a device that measures the relation between the emitted and received electromagnetic signals in a wide range of frequencies from coils placed on a patient can be transmitted through a cellular phone to a central substantially remote data processing facility. The raw data can be analyzed either in relation with an available data base or through signal processing and the occurrence of internal bleeding can be noted to the patient site either as a visual message, or through a sound message, or through an SMS message. This concept could be particularly valuable to women in remote villages or clinics or in an ambulance where data processing and analysis may not be readily available. In a remote village that has cellular phone data transfer technology a women after childbirth could be connected to two electromagnetic coils. The raw data could be continuously transferred through the cellular phone to a remote central facility, for instance in a nearby major village. Once internal bleeding is detected, the information is send back to the cellular phone that transmits the raw data and the woman with internal bleeding could be immediately transferred to a large city hospital, thereby saving her life. Similarly in an ambulance a patient who has developed internal bleeding in the head could have their condition detected while on the way to the hospital by sending the raw data ahead of the ambulance through a cellular phone to the data processing facility at the hospital. This could make the delivery of proper treatment more rapid.

It should be emphasized that the systems described in this invention are different from conventional telemedicine. While in conventional telemedicine the data that is transferred is processed data in the system of this invention the data that is transferred is unprocessed or minimally processed data. This has the advantage that the components at the site of the patient can be substantially less complex requiring less maintenance and reducing cost. It should be further emphasized that the system of this invention deals with the use of commercial cellular phone technology in which the providers support general cellular phone services. The non-specificity of the data transfer technology substantially reduces the cost of using this concept. Furthermore the use of conventional commercial cellular phones does not employ hard wiring for transfer of data between the different components of the distributed system. This has the advantage that the technology described here does not require a hard-wired infrastructure and can therefore be used in locations that do not have access to the infrastructure such as in remote or limited resources villages and clinics, in ambulances or in the field. In various embodiments, the raw image data could correspond to optical data (pictures) and that the work performed at the data processing facility includes both quantitative and qualitative parameters, rather than simply creating an image. This approach can also be applied to other imaging modes. For example, the remote processing site could analyze mole pictures to asses whether they could correspond to melanomas. “Continuous mole monitoring” is now considered one of the best methods for early detection of melanomas. Presently, some dermatologists make use of digital pictures to track changes in size of morphology of specific moles. This is a tedious task that involves visits every few months.

In optional aspects of the present invention, a similar process can be used with the camera of the cellular phone being used by patient to make pictures of specific moles as instructed by dermatologist or of new moles (some special lighting may be required). Next, the pictures would be sent to the data processing center, and then analyzed to detect significant changes (i.e.: comparing the pictures to previous patient pictures already stored in the central data center). As such, the present system could be used to determine whether any new or existing moles are becoming suspicious, and therefore whether a visit to a dermatologist is recommended or not.

### b) Medical Imaging Experimental EIT Results:

The present inventors have built, operated and experimentally verified the present invention using EIT components and systems described below. It is to be understood that the present invention may be carried out using other devices and processes, all keeping within the scope of the present invention.

An EIT scan is generally performed by placing a series of electrodes in a predetermined configuration in electrical contact with the tissue to be imaged. A low-level electrical sinusoidal current is injected through one or more of the electrodes and a resulting voltage is measured at the remaining electrodes. This process may be repeated using different input electrodes, and electrical currents of different frequencies. By comparing the various input currents with their corresponding resulting voltages, a map of the electrical impedance characteristics of the interior regions of the tissue being studied can be imaged. It is also possible to map the impedance characteristics of the tissue by imposing a voltage and measuring a resulting current or by injecting and measuring combinations of voltages and currents. By correlating the impedance map obtained through an EIT scan with known impedance values for different types of tissues and structures, discrete regions in the resulting image can be identified as particular types of tissue (i.e., malignant tumors, muscle, fat, etc.)

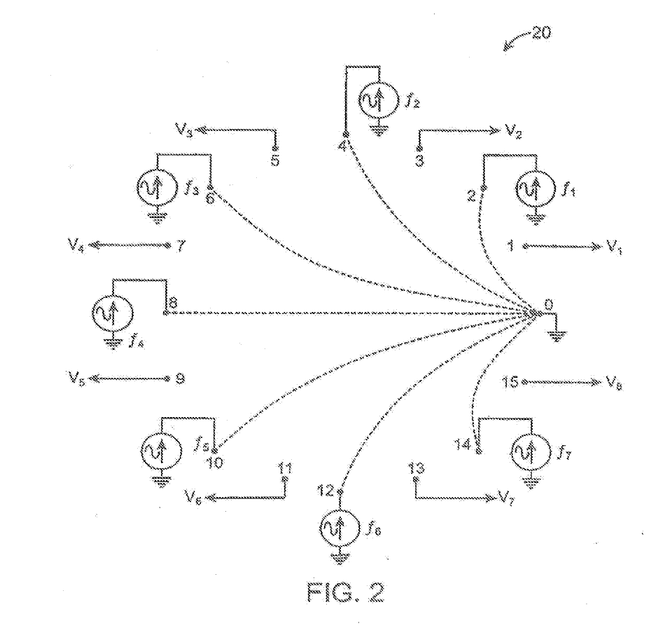

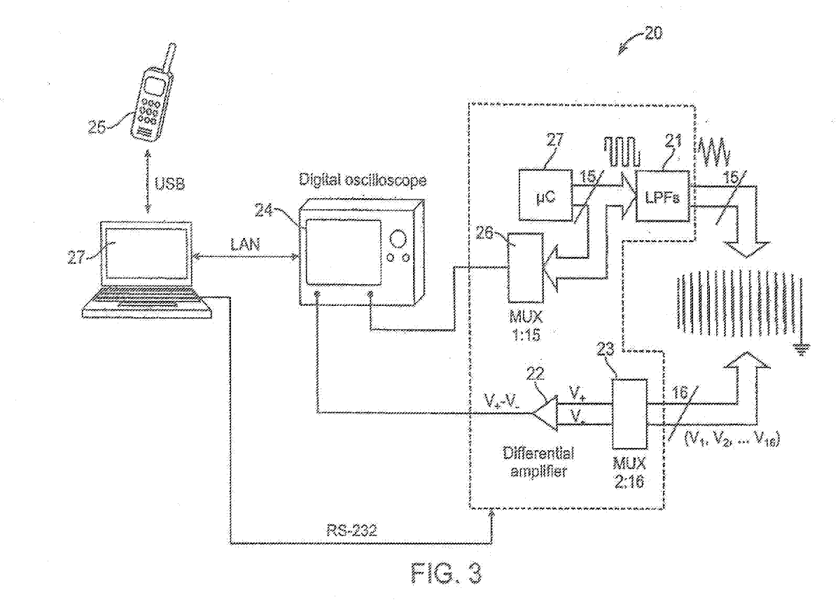

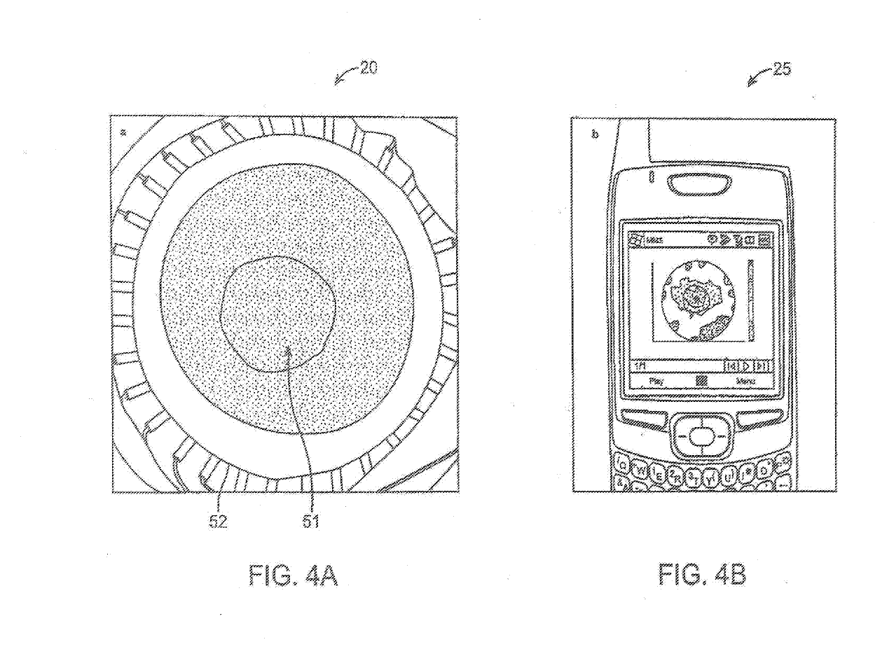

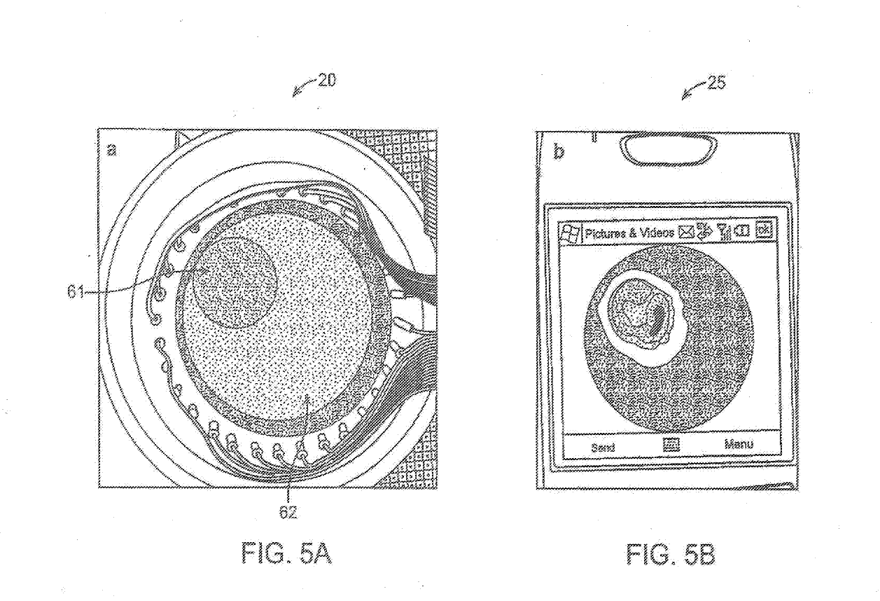

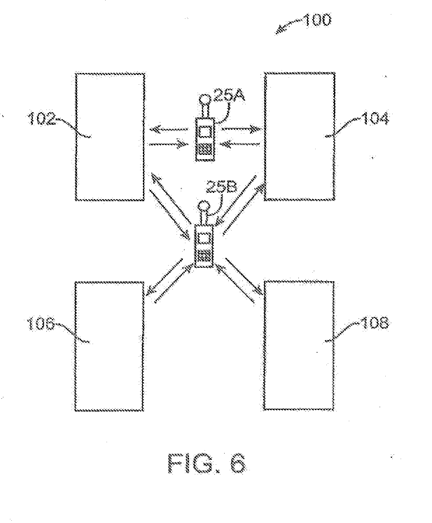

FIGS. 2 to 5B illustrate experimental system configurations and resulting images produced in accordance with experimental EIT testing of the present invention. Specifically, FIG. 2 is a schematic representation of a frequency-division multiplexing EIT technique carried out by the exemplary data acquisition device of FIG. 3. Details on the frequency multiplexing system can be found in: “Yair Granot, Antoni Ivorra, and Boris Rubinsky, “Frequency-Division Multiplexing for Electrical Impedance Tomography in Biomedical Applications,” International Journal of Biomedical Imaging, vol., 2007, Article ID 54798, 9 pages, 2007. doi: 10.1155/2007/54798”. FIG. 4A shows a data acquisition device used with a gel representing a tissue area treated with electroporation surrounded by normal tissue, and FIG. 5A shows a data acquisition device used with a gel representing a breast cancer tumor surrounded by normal tissue. FIG. 4B shows the processed image corresponding to FIG. 4A, and FIG. 5B shows the processed image corresponding to FIG. 5A.

In one aspect, as illustrated in FIGS. 2 and 3, data acquisition device 20 is an electrical impedance tomography system that comprises: a set of electrodes (1, 2, 3, 4, 5, 6, 7, 8, 9, 10, 11, 12, 13, 14 and 15 in FIG. 2) to inject currents or measure voltages; a current source 27 to send a predefined set of currents to the set of electrodes; at least one analog to digital converter to measure voltages from the set of electrodes; a system controller; and a communication port to communicate with cellular phone 25. Advantageously, there is no need for a powerful central processing unit (CPU), hard disk or memory space or even a graphical display at the patient location. (Note: in FIG. 2, only sixteen electrodes out of an actual thirty two electrodes used in the experiment are shown for clarity).

As seen in FIGS. 4A and 5A, a set of electrodes (1, 2, 3, 4, 5, 6, 7, 8, 9, 10, 11, 12, 13, 14 and 15 in FIG. 2) were disposed around the tissue to be examined. A circular dish was used with gel representing the tissue samples. The needles had a length of 20 mm and the circular container had a diameter of 65 mm. Some of the set of electrodes were used for current injection, some of the set of electrodes were used for voltage measurement, and some of the set of the electrodes were used for both the current injection and voltage measurements. Specifically, fifteen electrodes were current sources, one was a current sink and sixteen were used for voltage measurements. Each current electrode injected an AC type current (amplitude 80 uA) at a different frequency. The frequencies were all in the 5 kHz to 20 kHz band (for which the conductance of physiological solutions or gels is constant). The injected AC currents were obtained from square signals generated by a set of low cost micro-controllers 27 (PIC16F76 by Microchip Technology, Inc.) that were filtered by second-order low-pass filters (LPFs) 21 (as shown in FIG. 3) with a quality factor (Q) of 4 and centered at the frequency of interest.

A differential amplifier 22 (AD830 by Analog Devices, Inc.) was connected sequentially to different voltage electrode pairs by means of an analogue multiplexer 23 (MUX 2:16). The signal was then acquired by a digital oscilloscope 24 (LeCroy, WaveRunner 44Xi). Oscilloscope 24 also recorded the voltages from the current injectors through another analogue multiplexer 26 (MUX 1:15). All the recorded signals are acquired by a laptop computer 27 (IBM ThinkPad T43) with a LAN connection to oscilloscope 24.

Cellular phone 25 was a Palm Treo 700W. All of the AC signals (each at a different frequency) were injected simultaneously. Signals from voltage electrodes (V1 to V8) were connected to analogue multiplexer 23 (In a clinical device, computer 27 and oscilloscope 24 will be most likely replaced by dedicated components.)

The current source was based on a Tektronix AFG 3102 signal generator connected to 27 (not shown).

The dashed-area of FIG. 3 contains the elements that were implemented on a single printed circuit board: a microcontroller (not shown) reads incoming commands from the computer (through the RS-232 connection) and, according to these commands, manages the digital control lines of the analog multiplexers 26 and 23 (i.e. MUX 1:15 and MUX 2:16).

The whole process was performed through custom developed LabVIEW routines (National Instruments Corporation, Austin, Tex.). Using FDM (frequency division multiplexing) EIT, the voltage measurements were separated according to frequency. The different current patterns that were injected simultaneously are correlated with the voltage measurements. The signal processing routines that extract the voltage data were based on the Fourier transform and were implemented in Matlab (www.mathworks.com). In the last step of processing at the cellular phone site, the computer 27 transmitted the resulting raw data through cellular phone 25 by means of a USB connection. The format of the raw data is detailed below.

A total of fifteen electrodes injected a current to a single sink as explained above, but it is to be understood that various other patterns may be used as well. For each current there were fifteen independent voltage pair measurements (electrodes 1-3, 3-5, . . . , 29-31) which were obtained by the FFT (Fast Fourier Transform) as detailed above. Since there are fifteen current injections and for each one fifteen voltage measurements, there were a total of two hundred and twenty five measurements taken.

The measurements were arranged in a matrix to be transmitted to the processing center. Every measurement was written in a row of the matrix. The columns described the injected signal's frequency, the injecting electrode number, the positive voltage electrode number, the negative voltage electrode number, the measured voltage amplitude and the phase. For predefined patterns, it was sufficient to report only the last two columns. In our experiments, this matrix is 225 rows by 6 columns and its size is 4 kB. This matrix was uploaded to cellular phone 25, which dials the processing center 30 and uploaded the matrix though a standard HyperTerminal data link.

In data processing computer 27, a Matlab program was used to reconstruct the image which was sent back to cellular phone 25 in the form of an ordinary multimedia message using the cellular phone service provider's standard web-based interface. The Matlab program was based on EIDORS (see paper of Granot et al above). However any other EIT reconstruction algorithms could be used. Cellular phone 25 was connected to computer 27 via a USB data cable interface.

FIG. 3 illustrates an experimental embodiment to verify the operation of the present invention. As such, computer 27 is merely simulating the operation of facility 30 (in FIG. 1). As such, the embodiment of the invention shown in FIG. 3 was merely built to show the operation of successful data acquisition (by data acquisition device 20) followed by successful transmission of the processed image to the screen of cellular phone 25. It is to be understood that computer 27 (located between data acquisition device 20 and cellular phone 25 in FIG. 3) is specifically not required in accordance with the present invention. Rather, as shown in FIG. 1, the computer processing resides at facility 30 (with data acquisition device 25 being positioned between cellular phone 25 and facility 30).

In order to reconstruct the image from the voltage measurements that were sent from cellular phone 25, a Laplace equation over the entire tissue was solved. Specifically, by injecting a set of currents known as a current pattern and from performing voltage measurements, the boundary conditions of the tissue were determined. Thus, the internal conductivity of the tissue was computed. A Finite Element Method (FEM) was used to compute the voltages resulting from applying the current pattern and these were compared to the measured voltages. When they matched, the conductivity was determined.

FIG. 4A and FIG. 5A illustrate testing in two situations of interest to medical imaging: minimally invasive surgery with irreversible electroporation (FIG. 4A) and cancer tumor detection (FIG. 5A). In both cases, gels were used in a two dimensional configuration to simulate the conductivity of different tissues.

In FIG. 4A, a gel is shown with the electrical properties of irreversible electroporated liver tissue (0.93 mS/cm) nested within a gel with electrical properties of normal liver tissue (0.65 mS/cm). Simulated electroporated region 51 and normal liver region 52 are shown. The border between regions 51 and 52 were manually marked between the two gels to help identify the location of the inhomogeneity and to compare the reconstructed image to the actual location of the gel. The conductivity of the gel in region 52 is 0.65 mS/cm which is similar to that of a normal liver tissue. A cylinder was cut in the central part of the gel and replaced it with another gel 51 with a higher conductivity of 0.93 mS/cm which is similar to the conductivity of a liver after irreversible electroporation. FIG. 4B shows the resulting on-screen medical image as seen on cellular phone 25.

In FIG. 5A, a simulated breast cancer tumor 61 is shown (having a conductivity of 6 mS/cm @ 100 kHz) (upper left side circle) surrounded by normal tissue 62 (0.3 mS/cm @ 100 kHz), FIG. 5B shows the resulting on-screen medical image as seen on cellular phone 25.

In summary, these experiments demonstrated the successful use of a cellular phone as an integrated and enabling part of a medical imaging system in which the data acquisition component is connected to the imaging processing site through a commercial cellular phone. This concept has the potential for reducing the cost of medical imaging devices, and because of the wide availability of cellular phones and commercial cellular phone services produces medical images in a way that could bring state-of-the-art medical imaging to people and places that are not able to afford more standard equipment. Potential medical applications include, but are not limited to detection of tumors, disease and internal bleeding.

The present invention is easily scalable and could be used in a very similar manner for 3D EIT. Specifically, with the increase in number of electrodes, or the number of current patterns that are used, the size of the measurement matrix increases slightly and in a linear fashion while the requirements from the processing center in terms of memory and processing power increase significantly, usually in a quadratic fashion. This makes the system scalable with only small changes to data acquisition device 25, which is typically the hardest place to implement changes in terms of logistics and cost.

### c) Data Transfer Applications:

As described fully above, the present invention is ideally suited for transferring (medical or non-medical) images that use raw data (sent by cellular phone 25) and then display processed images on cellular phone 25's screen.

It is to be understood, however, that the full potential of the present invention involves data transfer between component parts of any complex device or system—where a cellular phone and commercial cellular phone services are used for data transfer between the component parts of the device or system. Thus, an advantage of the present invention is that it can use a cellular phone as a “middle node” in a system, complex device or machine. An advantage of the present use of a cellular phone as a “middle node” in a system, complex device or machine is that it can be used to replace hard wiring. As such, the various component parts can be separated and placed in substantially distant physical locations, that may be economically or geographically more advantageous. Using commercial cellular phone services for data transfer between the components of a system can substantially reduce the cost of standalone systems because it can remove redundancy in the cost of components. The availability of commercial cellular phone services substantially reduces the cost of data transfer for such systems.

The present invention provides for a system in which cellular phones are used as an integral, internally embedded and enabling component that transfers data among the components of the system, in a system with substantially distant spatially dispersed components. The entire complex is comprised of the data acquisition component, the cellular phone using a commercial non-dedicated data transfer service component and the data processing component. They are geographically separated but function as an integrated system through the use of cellular phone.

In such alternate aspects, as seen in FIG. 6, the present invention provides a system of transferring data between parts of a complex device using cellular phone communication protocols: comprising: a first system component 102 of a complex device 100; a second system component 104 of complex device 100; and a cellular phone-type device (25A), wherein raw data is sent through cellular phone-type devices 25A from first system component 102 to second system component 104. An example of a non-medical application is interior mapping of ground in the field, such as for identification of oil fields. Systems 106, 108 may be a set of pressure transducers located in the field around a geographical area of interest. A local detonation 100 can produce pressure waves that are recorded in 106 and 108. The raw data is send to 102 and the information processed to produce a map of the soil in the area of interest. Site 104 may be a complex data base of information that could be at a different location from the data processor in 102 and used by 102 to compile the image. As shown by the bi-directional arrows in FIG. 6, data is transferred by cellular phone 25A back and forth between components 102 and 104 (such that components 102 and 104 need not be hard wired together.

As is also seen in FIG. 6, a second (optional) cellular phone 25B is also provided. As illustrated, cellular phone 25B may be used to transmit data between any of first and second components 102 and 104, and also between third component 106 and fourth component 108. Thus, the present invention broadly encompasses using one or more cellular phones for data transmission between or among various components of a complex device.

The present invention thus encompasses the concept of a cellular phone as a “middle node” in any complex system. This is an important advance over all prior art systems where a cellular phone is simply the “end node” of a complex telecommunication network.

Similar to the above described systems, cellular phones 25A and 25B may be any cellular phone, PDA or Blackberry™, and data transmitted through the cellular phone may be sent by the cellular phone by e-mail, SMS, MMSTelnet. Moreover, such data may be transmitted as analog data through a voice channel of the cellular phone. The data sent through cellular phones 25A and 25B is raw unprocessed data or minimally processed data.

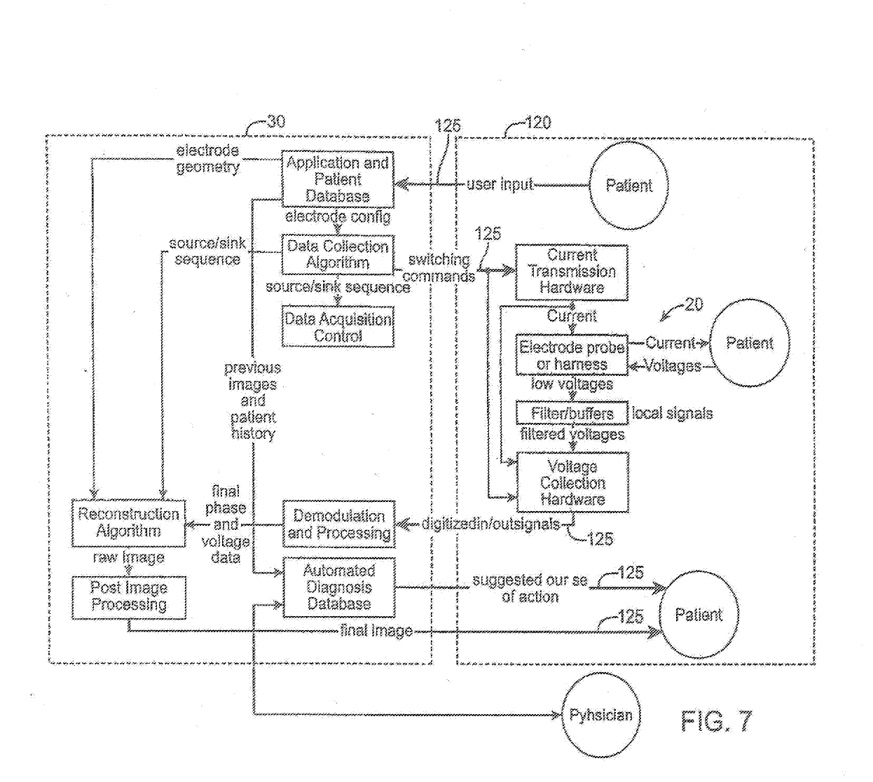

Lastly, as seen in FIG. 7, a distributed network can be seen in which cellular phones are used to transmit data. The system of FIG. 7 is similar in operation to the system set forth in Distributed Network Imaging and Electrical Impedance Tomography of Minimally Invasive Surgery, Technology in Cancer Research & Treatment, ISSN 1533-0346, Vol. 3, No. 2, 2004. In this system, facility 30 comprises a remote central facility, and patient site 120 comprising the patient and data acquisition device 20. However, in accordance with the present invention, the data transmitted between patient site 120 and central facility 30 is transmitted by cellular phone (using methods as described above). Specifically, data transmitted at lines/pathways 125 may be transmitted by one or more cellular phones 25 (not shown).

### d) 3-D Ultrasound Implementation:

Ultrasonography is a medical imaging modality using sound waves to visualize internal anatomical structures such as tissues, muscles, and organs. The ultrasonic image is acquired by having a transducer emit a series of sound pulses into the body. Echoes are then reflected back to the transducer every time the sound waves encounter boundaries between organs or tissue structures resulting in a change of acoustic impedance. The echo grows with the magnitude of the change in impedance. By estimating the time that passes between the original sound wave and its echo, it is possible to determine the depth of the tissue structure which has generated the echo.

Typical sonographic scanners operate in a frequency range of 2-18 MHz. The increasing sound frequency results in a decreasing wavelength, which leads to higher resolution imaging. However, higher frequency transducers do not penetrate as deeply into the body as the lower frequency transducers. For this reason, superficial organs and tissues such as muscles, tendons, testes, breast, and neonatal brain are imaged at a higher frequency (7-18 MHz), which provides better resolution. Deeper structures such as kidneys and liver are imaged at a lower (1-6 MHz) frequencies with greater penetration but lower resolution.

Four primary imaging modes are used in medical ultrasound imaging. The A-Mode is the simplest mode of ultrasonic imaging (where A stands for amplitude). A-Mode uses a single transducer to visualize a single scan line through the body. B-Mode (where B stands for brightness) provides a scan-plane by applying a linear array of transducer elements to steer the ultrasound beam. The result of the received echoes is a 2-D image of the scanned plane with image brightness representing the amplitude of the echoes. In M-Mode, multiple B-Mode images are acquired, which allows the medical expert to observe the behavior of a specific point, or a region, over time. M-Mode is especially useful for imaging organs that are in constant motion, such as heart valves. Doppler Mode ultrasound uses the Doppler effect that occurs upon a sound wave encountering a moving object. The movement of the object produces a shift in the frequency of the returned echoes. Several imaging approaches use the Doppler effect, including Color Doppler and Pulsed Wave Doppler. Most of the Doppler imaging techniques are used for observing blood flow in tissues and vessels.

Conventional ultrasound produces a 2-D image. Successful use of ultrasound relies heavily on understanding the significance of the image displayed and optimal placement of the transducer through trained hand-eye coordination. A highly trained and experienced user of ultrasound must develop hand-eye coordination skills that enable them to create the mental 3-D picture of the human body, while watching 2-D images acquired by the ultrasound system. In other words, the user must know exactly how to position the ultrasound probe, at what angles to scan the probe, and how fast to move the probe along the patient's body to get a good image. Since medical personnel with such skill sets are scarce in economically disadvantaged parts of the world, medical imaging is usually unavailable or results in misdiagnosis and/or inadequate treatment.

Recent advancements in ultrasound technology and computing power have led to combining multiple scan data to create 3-D and 4-D ultrasound imaging. Three dimensional ultrasound image reconstruction, which is a relatively recent advancement in ultrasound technology, removes the need for high quality radiological expertise by allowing the physician to perform the scan without getting into the minute details of the data acquisition process; such as the precise probe angle and position. In 3-D ultrasound, the returning echoes are processed by a computer program resulting in a reconstructed 3-D volume image of the visualized organ. Four dimensional ultrasound imaging involves the addition of movement by stacking together frames of 3-D ultrasound in quick succession. A challenge with industrial 3-D and 4-D ultrasound systems is their prohibitive cost, which precludes their use in developing nations or small clinics that lack highly trained specialists.

On a highly abstract level, any typical ultrasound imaging system includes four primary components: a) a transducer unit—used to emit and receive acoustic waves and record the correlation between them; b) a control unit—used to control the operation of the transducer; c) a processing unit—used to convert the raw data acquired by the transducer into a human usable form, usually a visual image; and d) an imaging unit—used to display the visual image for diagnostic purposes. While most imaging systems include a data acquisition module (transducer and control unit) physically integrated with a processing module, the present invention is based on physical and spatial separation of these components. Using the communication ability of the cellular phone/modem, a simple, inexpensive data acquisition device may be used to collect and transmit raw data to a central station. At the central station, the raw data is processed and (optionally) reviewed by a medical expert. More specifically, provided herein is a fully functional 3-D ultrasound system in which 2-D raw ultrasound data, acquired at the patient site, is transferred through a telecommunication network to a central processing facility. At the central processing facility, the 2-D raw data is processed into a 3-D image (or other useful image). The 3-D processed image (or data) can then be made available to the data acquisition site or to an expert at any other location.

Previous known attempts of coupling an ultrasound device with a communication device, such as Wi-Fi adapter or a cellular phone, have focused on utilizing a communication device for the purpose of video-streaming the acquired and processed ultrasound image to a remote expert station. However, to the best of the inventors' knowledge, there are no available systems that transmit raw ultrasound data for processing at central processing station, which serves a large number of users and generates 3-D images from the raw data.

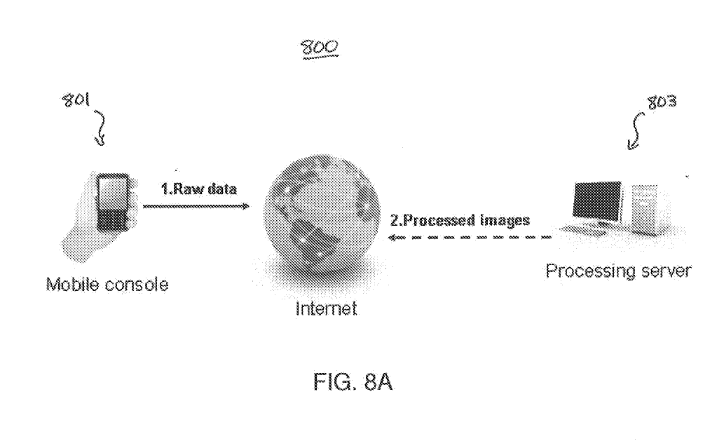

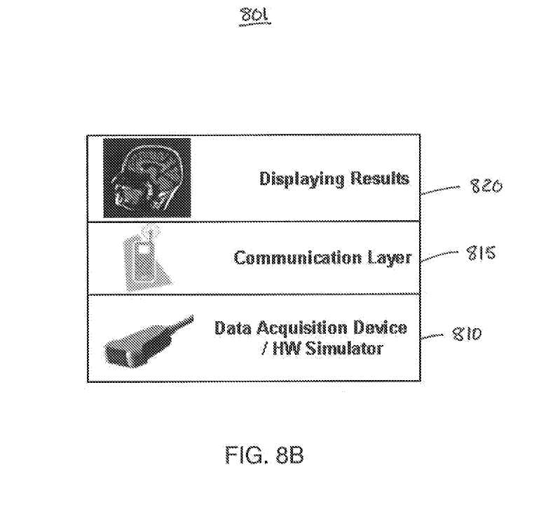

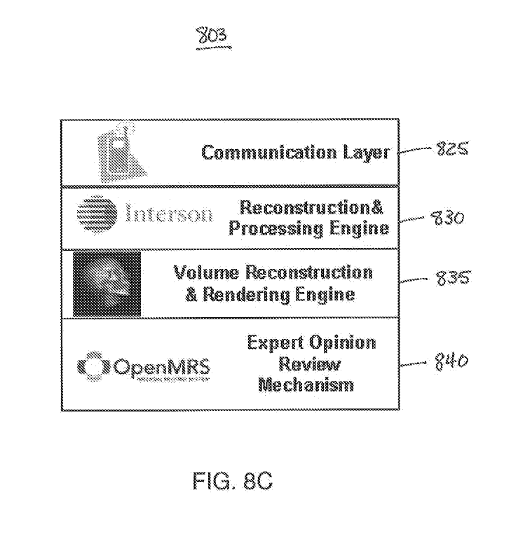

For example, one embodiment of the present invention is shown in FIGS. 8A-8C, wherein there is provided a medical imaging system 800 having a mobile console 801 and a remote processing server 803. The mobile console 801, with its associated sensors, acts as the data acquisition device that collects raw data from the patient and sends the raw data to the remote processing server 803 via an internet connection (as shown) or alternative communication network (such as a cellular network). The remote processing server 803 is capable of transforming large amounts of raw data into a human-understandable form, such as an image or diagnosis. By integrating the remote processing server 803 with an expert opinion review means (e.g., a network of remote expert physicians), a local health worker, at the patient's site, can gain access to medical expertise virtually anywhere in the world.

FIG. 8B illustrates an architecture for mobile console 801. The mobile console 801 contains a hardware data acquisition device 810, a communication component (or layer) 815 able to send raw data and receive results, and a display means 820. FIG. 8C illustrates an architecture of remote processing server 803. The remote processing server 803 contains a communication component (or layer) 825 to receive the raw data, a processing (reconstruction) component 830 to process the data into a useful form, and a visualization (rendering) engine 835 that shapes the data in a visually meaningful way. In one embodiment, remote processing server 803 also includes a human-assessment mechanism 840 that enables an expert physician to review the results before sending them back to the mobile console 801.

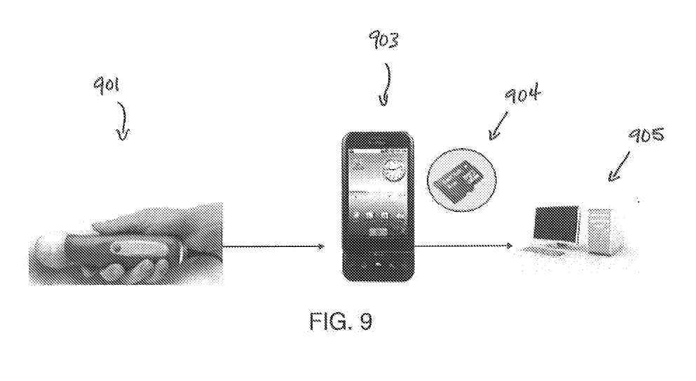

FIG. 9 is a schematic illustration of one example embodiment presented herein. The raw data flows from the acquisition device (e.g., an ultrasound probe) 901 to the mobile device 903, which is a mobile phone having a memory unit 904 acting as a storage device, and then transferred to a remote processing server 905 when a connection is available. Remote processing server 905 may be a Lenovo R61 1.5 GHz, 2 GB RAM Windows XP server test bed running application software, such as the processing engine and OpenMRS® server.

The OpenMRS server is used here to illustrate one possible embodiment of the transfer of the processed data to an expert able to interpret the data. Open Medical Record System (OpenMRS®) is an open source medical record system platform developed by an active online community for developing countries. OpenMRS® is a software platform that enables rapid design and prototyping of medical records management applications. The basis of the system is a conceptual database structure that is independent of the actual types of medical data to be collected, which enables the system to be flexible and customized to specific application needs.

The present invention leverages OpenMRS®'s flexibility to provide a framework for Global Expert Opinion; i.e., a subsystem which enables a medical expert located anywhere in the world to share his expertise with a remote health worker on the patient's site. By logging into a website, the medical expert can review the pending cases, review the images associated with the patient's case, and comment on the case. In addition, the OpenMRS® based system functions as an Electronic Medical Records database. By integrating the remote processing server 905 with the OpenMRS® database, all the patients' records are centrally stored in an orderly fashion. Once the raw data of the patient has been processed and analyzed, it is added to the list of pending cases and is available for the review of a medical expert. The expert may then comment and send feedback to the local health worker in the field.

In one embodiment, the processed data and/or image can be sent to an expert's (e.g., a physician, radiologist, ultrasound technician, etc.) computer or cell phone, or non-expert's (e.g., patient, patient's family, insurance provider, etc.) computer or cell phone. The processed data and/or image can be sent in the form of a 2-D or 3-D image with or without comment from another expert or non-expert.

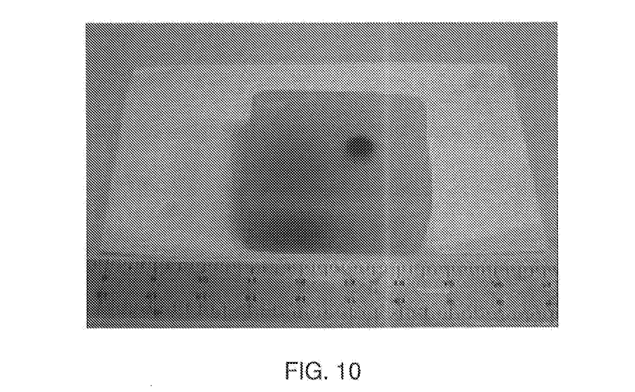

FIG. 10 is a photograph of an experimental agar based box-shaped phantom, developed to test an embodiment of the present invention. An agar based box-shaped phantom, sized 3.5″×2.75″×2″, was created with a marble ball, a peach pit, and two cherry pits embedded inside the phantom. The marble ball can be seen from the image provided in FIG. 10.

For the purpose of experimentation, the inventors focused primarily on data flow in a typical obstetrics ultrasound scan, performed in B-Mode, with spatial resolution of 256×256, maintaining a contrast resolution of 8 bits (256 shades of gray). In such an experiment, the raw data required for the reconstruction was acquired by driving the transducer in a rectilinear, uniform direction with constant speed over the phantom. The number of slices acquired depends on the specific application, so the inventors used 80 slices in their study. The inventors used a standard, inexpensive 3.5 MHz abdominal ultrasound probe manufactured by Interson Corporation for 2-D ultrasound.

The inventors' experiment was based on Google's Android platform, which was chosen because it is fully open source and capable of utilizing all the modern features provided by cellular operators. The system was tested in two configurations: a) running on HTC G1 mobile phone, and b) running in an emulator environment on Asus EEE 1000HE netbook computer.

Since USB host mode is not enabled on the conventional HTC G1 phone, it was not possible to connect the USB ultrasound probe to the mobile phone. For this reason, the inventors designed a frame-grabber software module, which is responsible for capturing the raw data from the ultrasound probe and sending it to the G1 phone over short-range wireless network. The inventors used the same frame-grabber interface when they tested the system in an Android emulation environment running on Asus netbook. Android-powered netbooks are expected to appear in the nearest future and thus the inventors envision their system running natively on those computers, getting the ultrasound data directly from the available USB port.

Cellular data channels available today are still limited when compared to broad-band Wi-Fi alternatives. Even HSDPA, commonly referred to as 3.5G, provides 14.0 Mbps downlink under optimal conditions and HSUPA, which is the uplink component of 3.5G, provides an uplink of up to 5.76 Mbps. These limitations are especially true in developing nations where available cellular services tend to lag behind the cutting edge technologies available in the developed world. These limitations are noteworthy because medical imaging devices are often known for generating large quantities of data. For this reason, it is important that the mobile console provides a buffering zone between the actual sensor and the processing station. Even if the connection channel is low-speed and/or unreliable, given enough storage space, the mobile console will eventually succeed to send the data to the processing station once the connection becomes stable. An alternative scenario might involve a local health worker acquiring large amounts of data from multiple patients and later, when a Wi-Fi connection is available, uploading all the accumulated data to the remote station for processing. Fortunately, the costs of memory have dropped dramatically in the recent years, so the buffering problem can be efficiently solved; i.e., the mobile device (netbook/cellular phone) can accumulate the data on it's internal memory card until connection for uploading this data is available.

Since the inventors' purpose was to generate 3-D images, a system to provide positional information was needed. In an alternative embodiment, a truly freehand 3-D ultrasound positioning system may be used. The inventors, however, used a handheld steadily moved 3.5 MHz general purpose abdominal probe to avoid the need for a more complex positioning system. The inventors intentionally chose to work around the position information problem since the focus of their work was to confirm the feasibility of the overall data acquisition and 3-D processing framework. (Alternatives for position and orientation estimation are provided below.)

For performance evaluation, relevant measurements are summarized in the table below.

| | | |
|---|---|---|
| Raw data size for a single B-Mode raw image | 512 | kB |
| Average raw data transfer for a single B-Mode | 3.9 | sec |
| raw image data (Wi-Fi) | | |
| Volume rendering of 80 slices | 28 | sec |
| Snapshot generation for angular resolution of | 115 | sec |
| 10 degrees, yielding 36 projections per | | |
| rotation axis | | |
| 36 Angular snapshot images transfer back to | 31 | sec |
| the mobile console (Wi-Fi) | | |

Substantial amounts of raw data are transferred over the wireless connection, thus the round-trip time is not real-time. Although it is possible to make the system more efficient by using various data compression and channel quality adaptive algorithms, due to the nature of the 3D ultrasound, the need for real-time feedback is removed because no hand-eye coordination is required. The relatively unskilled health worker can acquire the data in a freehand manner and, after the remote processing is done, have the complete 3-D volume data available for review and diagnostic purposes.

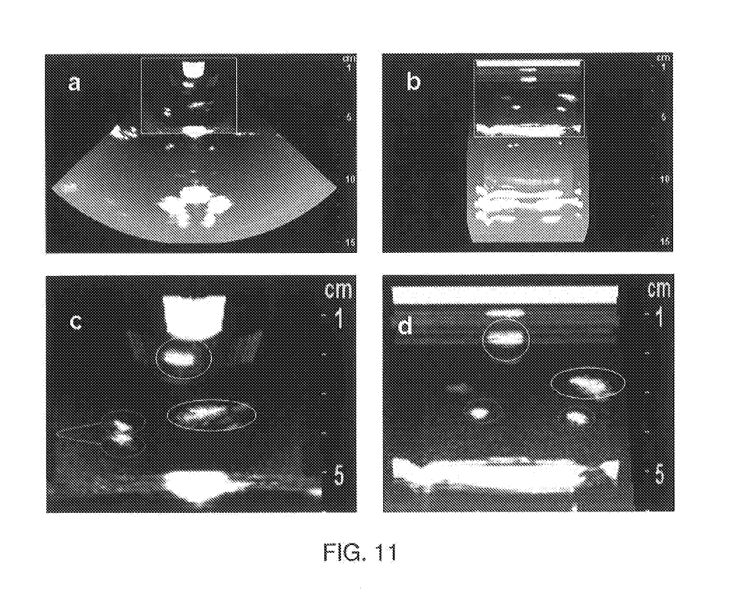

FIG. 11 provides ultrasound images of the experimental phantom of FIG. 10. A snapshot of the 3D reconstructed phantom is presented in multiple projection views (images (a) and (b)). The region of interest (ROI) is shown in higher zoom level (images (c) and (d)) where the marble ball can be seen on the top, the peach pit on the right, and two cherry pits on the left part of the scan (c). More specifically, image (a) is a front projection, axial angle 0°, at depth of 15 cm. Image (b) is a side projection, axial angle 90°, at depth of 15 cm. Image (c) is a zoom on ROI from image (a)—the cherry pits, the peach pit, and the marble ball are clearly seen. Image (d) is a zoom on ROI from image (b)—the cherry pits, the peach pit, and the marble ball are clearly seen.

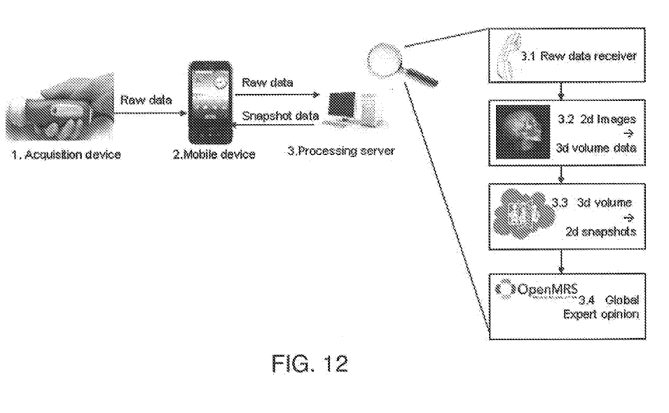

FIG. 12 is a schematic illustration of one embodiment presented herein. More specifically, FIG. 12 shows the flow of data of an embodiment of the present invention. First, the raw data is collected by the acquisition device (e.g., an ultrasound probe). The raw data is then transmitted to a mobile device, which stores the raw data on its internal memory card until a reliable connection channel becomes available. The mobile device then periodically (frequency can be configured trading-off responsiveness versus battery life) tests the available connection in order to detect the right moment to send the data to a remote processing server. Once a connection has been established, the data transfer begins to the remote processing server. In one example, the communication protocol between the mobile device and the remote processing server is based on XML-RPC, which in turn is based on the standard HTTP protocol for transport. The raw data is packaged in a way that supports operating in slow, unreliable connection channels.

The raw data flows from the hardware acquisition device to the mobile console, which acts as a storage and communication conduit. Once all the raw data arrives to the processing server, the processing stage can begin. The data is grouped by the relative slice number. A stack of parallel slices are turned into a volume data-set for later manipulation. In one example, such processing may be achieved using the “DICOM Volume Render” open source software module by Mark Wyszomierski, which is based on the popular graphics engine VTK.

Digital Imaging and Communications in Medicine (DICOM) is a standard for handling, storing, printing, and transmitting information in medical imaging. In addition to the raw image data, DICOM format enables incorporation of various meta-parameters, for example, slice sickness, slice number, etc. After the process of generating the DICOM files is complete, the renderer can process the stack of 2-D images in DICOM format and create a volumetric data-set which is later snapshot to generate multiple view projects for 3-D visualization.

After the volumetric data-set has been created, it is projected in multiple directions to create the effect of 3-D viewing on the mobile device. Given a high enough angular resolution, the effect is close to a full 3-D manipulation in the commonly used axial, sagittal, and coronal planes. It's worth noting that recent technological advances in mobile devices, specifically in CPU power and graphic processing abilities, already allow many cellular phones to perform 3-D rendering on the mobile unit itself. The trade-off decision of battery life versus visualization power will have to be taken into account by any application designer in the mobile medical imaging field.

After the projections have been generated, they are saved as JPEG formatted images which are sent back to the mobile device, again using the XML-RPC over HTTP protocol. By using JPEG images as opposed to sending the volumetric data and rendering the data on the mobile device, only the image-displaying capability of the mobile device are engaged; as opposed to it's power-hungry 3-D engine, thus saving precious battery life. In an alternative embodiment, a WINDOWS Bitmap, WINDOS Metafile, TIFF, Targa, RAW, PNG, GIF, or equivalent image format may be used.

Due to the nature of a mobile device, its IP address is highly unstable. The cellular network might decide at a certain point that the IP address of a certain mobile device has to be changed. An IP address change makes it difficult for the server to contact the mobile console to notify it that the processing was completed and results are pending. Even if the mobile console sends its ID to the server, in the time period between the raw-data transmission to the termination of the processing phase, the IP address might have been changed. For this reason, a console-driven polling mechanism may be implemented. Once the raw data has been sent, the mobile console may periodically poll the server to ask if the results are ready. If and when the results are ready, the mobile console makes a request for the results. The frequency of the polling procedure is a system parameter that can be configured to trade off responsiveness versus battery life. In one embodiment, a frequency of 30 seconds provides reasonable results. Once the data is processed on the remote processing server, the results are transferred back to the console for review and diagnosis.

To provide an optional expert opinion to the remote health worker, the present invention may be integrated with OpenMRS®. Once the raw data has been reconstructed and 3-D images are available, the processed images are displayed in a “pending” queue in OpenMRS®. After a medical expert reviews the data and adds his comments, the result is sent to the mobile console for display. The expert reviewing the diagnostic images can be with the patient, or at any geographic location, unrelated to the location of the patient, health worker, and/or the processing station. As used herein, the term “diagnostic image” is intended to mean the complete image (in 2-D or 3-D), or a portion of interest, or slice of interest, of the complete image (in 2-D or 3-D).

An aspect of any 3-D ultrasound system concerns position and orientation information. During the process of 3-D image reconstruction, every surface element (pixel) from the 2-D images is mapped to a volume element (voxel) in the 3-D reconstructed volume. To perform such a mapping accurately, the reconstruction algorithm needs to know the precise position and orientation of the ultrasound probe at the moment of the 2-D image acquisition. There are several techniques to this end. Electro-magnetic and optical technologies for ultrasound probe tracking are the most popular tracking technologies. While those approaches provide good accuracy, they are also relatively bulky and expensive. However, micro electro-mechanical systems (MEMS) may be used to estimate position and orientation in 3-D. An Internal Measurement Unit (IMU) may be provided with an accelerometer and a gyroscope. The advantage of this approach is its simplicity—no external camera or receiver is needed, as in the electromagnetic/optical technology case. The raw physical measurements (acceleration, angular velocity and static orientation) are read from the IMU and processed to calculate the absolute 3-D position and orientation. By adding redundant sensors, it is possible to compensate for some of the numeric errors inherent to the process. Alternatively, a conventional digital camera may be used for position and orientation estimation. During the data acquisition process, in addition to the ultrasound data, a video clip focusing on the ultrasound probe may be captured. After the acquisition process is over, the position and orientation information may be extracted by applying machine vision algorithms to the acquired video stream. By using a conventional digital camera, which often comes as an integral part of any modern cellular phone, it is possible to build a low-cost, ultra-mobile 3D position mechanism.

Alternatively, the 3-D positioning issue can be worked around by steadily moving the ultrasound probe in a straight line during the data acquisition stage. By sticking to the straight line trajectory, a user can use a more straightforward reconstruction algorithm that simply stacks the 2-D images, one next to the other, and still get 3-D images of reasonable quality.

The embodiments presented herein can serve large numbers of remote users by allowing local health workers to employ an inexpensive technology to obtain a 3-D ultrasound image, at a fraction of the cost and without the need for complex data processing facilities and software at the user site.

Although certain embodiments focused on ultrasound images, the implementation of any another medical technology would be identical in its conceptual essence. The ultrasound was chosen due to its mobility and wide availability, which makes it the natural choice of medical diagnostic modality for the developing world.

An alternative and conceptually similar system may include integrating a data acquisition device, such as an ultrasound probe, with a cellular-phone chip such as, for example Gobi or Snapdragon technologies by Qualcomm. Such a system may include a display that is capable of displaying the diagnostic information after the remote server has finished processing the raw data. Such a system may be utilized in a consumer device. The possible drawback of such architecture is binding the medical device to a specific cellular technology such as CDMA or GSM. A solution to this problem might include a Bluetooth transmitter in the end device that will send the raw data to any standard cellular phone; most modern phones include Bluetooth capabilities in them. Such a system may be used to perform the scan by a health worker or even a home user. The raw data acquired by the data acquisition device may be sent to remote station for processing and a diagnostic result in the form of a text message would be displayed on an LCD line: e.g., “Healthy” or “Thorough test is required.” Javing such a device would enable early detection of diseases, such as cancers or internal bleeding.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of providing a patient with medical imaging technology, comprising:
providing an ultrasound transducer and a wireless data transfer device at the patient's site;
acquiring raw two-dimensional ultrasound data from the patient using the ultrasound transducer;
transferring the raw two-dimensional ultrasound data from the ultrasound transducer to the wireless data transfer device;
transmitting the raw two-dimensional ultrasound data to a remote processing server with the wireless data transfer device; and
constructing a three-dimensional ultrasound image from the raw two-dimensional ultrasound data.

2. The method of claim 1, wherein the wireless data transfer device is a cellular phone.

3. The method of claim 1, further comprising:
transmitting a diagnostic image from the remote processing server to the wireless data transfer device based on the three-dimensional image.

4. The method of claim 1, further comprising:
transmitting a diagnostic image to an expert.

5. The method of claim 1, further comprising:
transmitting a diagnostic image to a non-expert.

6. The method of claim 1, wherein the raw two-dimensional ultrasound data is transmitted from the wireless data transfer device to the remote processing server by a wireless data transfer modality such as e-mail, Wi-Fi, Bluetooth, SMS, or MMS Telnet.

7. The method of claim 1, wherein the raw two-dimensional data is transmitted from the wireless data transfer device to the remote processing server as analog data through a voice channel of a cellular phone.

8. The method of claim 1, wherein the ultrasound transducer lacks a physically integrated processing unit.

9. The method of claim 1, wherein the diagnostic image is a JPEG, WINDOWS Bitmap, WINDOWS Metafile, TIFF, Targa, RAW, PNG, GIF, or equivalent image format.

10. A method of providing a three-dimensional image, comprising:
acquiring raw imaging data from a patient with a data acquisition device;
transferring the acquired raw data to a wireless data transfer device;
using the wireless data transfer device to transmit the raw imaging data to a remote processing server; and
constructing a three-dimensional image from the raw data at the remote processing server.

11. The method of claim 10, wherein the data acquisition device is an ultrasound transducer.

12. The method of claim 10, wherein the wireless data transfer device is a cellular phone.

13. The method of claim 10, further comprising:
transmitting a diagnostic image from the remote processing server to the wireless data transfer device; and
displaying the diagnostic image on a screen of the wireless data transfer device.

14. The method of claim 10, further comprising:
transferring a diagnostic image to an expert.

15. The method of claim 14, wherein the expert is at a location different from the patient or the remote processing server.

16. The method of claim 14, wherein the expert transmits a diagnosis to the wireless data transfer device for the patient to receive.

17. The method of claim 14, wherein the expert transmits a diagnosis to a non-expert.

18. The method of claim 10, wherein the raw data is transmitted to the remote processing server by a wireless data transfer modality such as e-mail, Wi-Fi, Bluetooth, SMS, or MMS Telnet.

19. The method of claim 10, wherein the raw data is transmitted to the remote processing server as analog data through a voice channel of a cellular phone.

20. The method of claim 10, further comprising:
transmitting data acquisition device positioning data to the remote processing server.

21. A system for providing three-dimensional ultrasound data, comprising:
an ultrasound transducer;
a cellular phone operatively coupled to the ultrasound transducer; and
a remote processing server that is linked to the cellular phone in order to receive raw two-dimensional ultrasound data from the cellular phone and construct a three-dimensional ultrasound image based on the raw two-dimensional ultrasound data.

22. The system of claim 21, wherein the raw two-dimensional ultrasound data is transmitted through the cellular phone by a wireless data transfer modality such as e-mail, Wi-Fi, Bluetooth, SMS, or MMS Telnet.

23. The system of claim 21, wherein the raw two-dimensional ultrasound data is transmitted through the cellular phone by analog data through a voice channel of the cellular phone.

24. The system of claim 21, further comprising an expert opinion network linked to the remote processing server to provide a diagnosis based on the three-dimensional ultrasound image.

25. A system for providing a diagnostic image, comprising:
a data acquisition device;
a wireless data transfer device operatively coupled to the data acquisition device; and
a remote processing server that is linked to the data acquisition device in order to receive raw two-dimensional data from the data acquisition device and construct a diagnostic image based on the raw two-dimensional data.

26. The system of claim 25, wherein the data acquisition device is an ultrasound transducer.

27. The system of claim 25, wherein the wireless data transfer device is a cellular phone.
